(19) United States
(12) Patent Application Publication
(10) Pub. No.: US 2021/0217261 A1
(43) Pub. Date: Jul. 15, 2021

(54) SMART SECURED REFRIGERATED DELIVERY RECEPTACLE SYSTEM

(71) Applicant: Huck Kootenai Green, Los Angeles, CA (US)

(72) Inventor: Huck Kootenai Green, Los Angeles, CA (US)

(21) Appl. No.: 16/740,325

(22) Filed: Jan. 10, 2020

(51) Int. Cl. G07C 9/00; G08C 17/02

(52) U.S. Cl. CPC G07C 9/00912; H04W 84/042; G08C 17/02

(57) ABSTRACT

A secured delivery receptacle system comprising refrigerated lockers suitable for permitting home delivery of groceries when the recipient is unavailable, is disclosed. The secured delivery receptacle system may be configured as a standalone unit or configured as to be installed into the exterior wall of a building, wherein the system and delivered packages are accessible from the inside of the building by the recipients, and accessible from the outside of the building by the delivery agent. The secured delivery receptacle system may further be equipped with various smart programing features in order to conserve energy and minimize heat loss.

### CONTINUITY AND CLAIM OF PRIORITY

This is an original U.S. patent application.

### FIELD

The invention relates to secured delivery receptacle systems for facilitating the delivery of parcels from sender to recipient, and refrigerated secured delivery receptacle systems to allow for the secured delivery of perishable items to the recipient, even when a person is unavailable to accept delivery.

### BACKGROUND

As online shopping has increased in popularity among consumers, so has home delivery of goods purchased online. Because most consumers work and delivery times for goods are unpredictable, often taking place during the work day, it is common for goods ordered online to be delivered to the door step of a consumer's residence. While some consumers who live in large apartment complexes or other similar living communities have staff members available to sign for goods and accept delivery, most consumers who live in smaller apartment complexes, townhomes, or houses usually don't have anyone available at their residence to accept delivery of a package. The practice of leaving packages on door steps or other exterior areas around a home has led to an increasingly large number of packages being stolen. Such thieves who steal delivered packages from unsecured locations outside of a home are commonly known as “porch pirates.” As such, a system capable of facilitating the secured delivery of packages from sender to recipient would be of great value to consumers and businesses who buy and sell goods online.

As an increasing number of retail business have moved online and are able to accommodate home delivery of purchased goods, many grocery stores are now offering home delivery of groceries. Unlike ordinary consumer goods which are generally non-perishable and can sit on a door step for many hours without spoiling, groceries can't safely be left in unrefrigerated conditions for more than 2 hours. Since groceries will spoil if left at room temperatures for too long, home delivery services for groceries generally require a person be home to accept delivery. The requirement that a person be home to accept delivery reduces what would otherwise be a much larger number of consumers ordering groceries online for home delivery. Accordingly, a system capable of facilitating the secured, refrigerated delivery of groceries, while the purchaser is unavailable to accept delivery for periods of several hours or more would be of great use to consumers and business in facilitating home delivery of groceries.

### SUMMARY

The invention relates to a smart secured delivery receptacle system and apparatus which may be equipped with refrigerated compartments to facilitate the delivery of groceries to customers without requiring an individual to be home to accept the delivery. The system presents a combination of elements in a novel configuration which provides enhanced accessibility to both the delivery agent and the recipient. Present embodiments of the invention may include a housing defining an enclosed structure, an exterior face located on the housing, first and second exterior access doors on the exterior face, at least one refrigerated delivery compartment which can be accessed through an access door located on the exterior face, with the temperature of at least one refrigerated delivery compartment being adjustable as to accommodate storage of frozen goods, at least one parcel locker which can be accessed through an access door located on the exterior face, securing means located on the housing and within the lockers for securing the lockers to prevent unauthorized access to the lockers, and a detection means in the lockers for detecting whether a locker is empty or occupied. They system may further include a central control unit connected to: the refrigeration components, allowing them to be turned on and off; the securing means; the detection means; and a user interface on the exterior face of the unit to accept user input. The system may further include a camera system for surveillance and security configured to record video and capture images from the exterior of the unit, and a battery back up system to allow for the unit to operate even in power outages.

The securing means may be magnetic locks or electronically enabled mechanical latches which are electronically connected to the control unit and user interfaces, and can be secured by the delivery agent upon delivery, and opened by the purchaser upon receipt. The user interface may be a touch-based display. The means for detecting whether a locker is empty or occupied may comprise an infrared sensor, weight sensors, or optical photo detectors and can be used to determine, or verify, that a particular locker is empty or occupied.

The central control unit of present embodiments may comprise a central processing unit, an electronic storage drive, a transmitter, a receiver, and internet connection means. The internet connection means may include access ports (such as ethernet) for accepting wired local area network connections, or a LTE (Long Term Evolution 4G wireless network) enabled transceiver and SIM card which enable communication over an LTE network. The central control unit may also include hardware necessary for 5G communications. The user interface and central control unit may be integrated into a single smart device, such as a smart phone or LTE enabled tablet.

The system may further comprise a camera on the exterior of the unit which records video or takes pictures when it detects input to the machine, or otherwise detects movement or the presence of a person in the area of the system. The camera configured to capture images or video from the exterior of the unit may store the recorded images or video on the electronic storage drive of the unit and may transmit the footage to the owner of the unit, upon request, or as is necessary in response to suspected tampering, theft, or vandalism. Transmission of the data may be accomplished by direct download, or communication over the internet using a LAN or LTE network.

The refrigerated lockers may include the traditional components of a refrigerator including: refrigerant lines connecting a radiator, compressor, expansion valve, and heat exchanger; a refrigerant; a compressor located within the housing; one or more heat exchangers located within the housing or on the exterior of the housing; expansion values located within the housing; interior fans located within the refrigerated delivery lockers; a thermometer located within the refrigerated delivery locker configured to start the compressor upon the locker reaching a specified temperature; a radiator located on the exterior of the housing; and optional exterior radiator fans. The refrigerated lockers should be configured as to turn only upon receiving a command from the central control unit, either in response to the input of a grocery delivery, or in response to an electronic confirmation of an incoming grocery delivery. Following removal of the grocery delivery form the refrigerated locker, refrigeration may cease as to conserve energy, unless a subsequent delivery is expected, or delivered. There may be refrigerant lines connecting the radiator, compressor, expansion valve, heat exchanger, and other components. The size of the refrigerated lockers may vary in given unit may vary in order to accommodate deliveries of varying size, conserve energy, and minimize the cooling time to bring the unit into the desired temperature range.

The secured delivery receptacle system of present embodiments may also be equipped with a battery as to allow for continuous operation of the system even during power outages. Depending on the incoming deliveries, capacity of the battery, and length of the outage, the system may be configured as to power only the user interfaces, central control unit, and securing means while not powering the refrigeration components as to extend the battery life and operating time of the unit.

The secured delivery receptacle system of present embodiments may be configured to be installed into an exterior wall of a building, as to allow the recipient to access it from the interior of the building, while allowing the delivery agent to access it from outside of the building. In such an embodiment, the secured delivery receptacle system will also comprise an interior face located on the housing, first and second interior access doors on the interior face permitting access to the parcel lockers and refrigerated lockers from the interior face of the unit, an additional user interface located on the interior face of the unit housing as to allow the recipients input commands to the unit and receive output, such as the input of a secure code or password necessary to open a corresponding locker. The system may be configured to be built into an exterior wall of a building and the lockers may be accessible from either side of the wall the system is built into. Such embodiments may further include intake and output air vents located within the housing beginning and ending at the exterior face, a convection based heat exchanger located within the housing and attached to the air vents, a second heat exchanger located within or attached to the refrigerated delivery locker, and a thermometer located within the refrigerated delivery locker configured to start the compressor upon the locker reaching a specified temperature. Further, there may be refrigerant lines connecting the convection-based heat exchanger, compressor, expansion valve, and second heat exchanger. Such an embodiment may be suitable for houses and single-family homes. For such embodiments, interior securing means may be unnecessary, and the system may be configured to allow interior access without requiring a pass code or substantive user input aside from opening the doors.

The secured delivery receptacle system of present embodiments may also be configured as a standalone unit secured to the ground where it is located. Larger standalone embodiments may be suitable for apartment communities or other communal living facilities which would benefit from a large, secured, refrigerated delivery receptacle system in a central location such as a mail room or parking garage. In such embodiments, it may be useful to utilize individual security codes generated in response to the delivery for specific tenants or addresses, and securely communicated to the recipient in electronic format as to allow them to open the locker and safely remove their delivery.

### BRIEF DESCRIPTIONS OF DRAWINGS

FIG. 1 shows a front view of a secured delivery receptacle system of present embodiments showing the combination of refrigerated delivery lockers, parcel lockers, and a user interface.

FIG. 2 shows a front view of a secured delivery receptacle system of present embodiments with electrical connections between the refrigerated delivery lockers, the parcel lockers, the securing and detection means, and the user interface.

FIG. 3 shows a perspective view of a secured delivery receptacle system and illustrates another aspect of the disclosure wherein the secured delivery receptacle system may be installed into the exterior wall of a building.

FIG. 4 shows a front view of a secured delivery receptacle system of present embodiments as it may be installed into the wall of a house.

FIG. 5 shows a side view of a secured delivery receptacle system of present embodiments as it may be installed into the wall of a building and illustrates the pass-through nature of the system, the intake/output air vents, and possible configurations of the refrigeration components.

FIG. 6 shows a back view of a secured delivery receptacle system of the embodiment of FIG. 5 as it may be installed into the wall of a house, being fully accessible from the interior of the house.

FIG. 7 shows a perspective view of a secured delivery receptacle system in accordance with yet another aspect and embodiment of the disclosure comprising a standalone secured delivery receptacle system.

### DETAILED DESCRIPTION

Embodiments of the present invasion relate to a smart secured delivery receptacle system and apparatus which may be equipped with refrigerated compartments to facilitate the delivery of groceries to customers without requiring an individual to be home to accept the delivery, are disclosed herein.

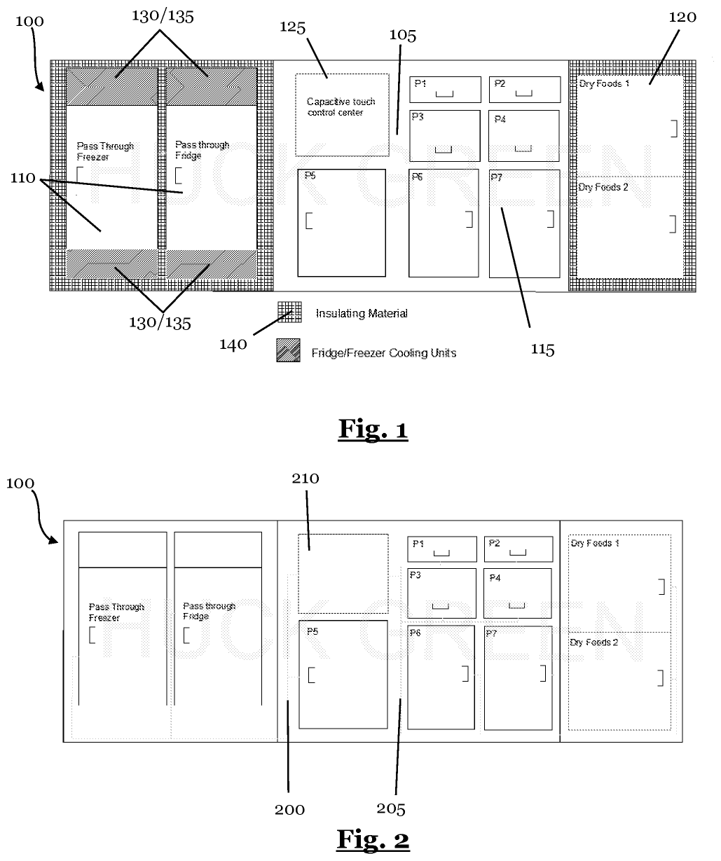

FIG. 1. shows a front view of a secured delivery receptacle system 100 of present embodiments. The secured delivery receptacle system 100 may comprise a housing 105 defining an enclosed structure, refrigerated lockers 110 located within the housing which can be accessed through a first access door located on the exterior face, parcel lockers 115 of various size located within the housing which can be accessed through a second access door located on the exterior face, dry food lockers 120 located within the housing which can be accessed through a third access door located on the exterior face, a user interface 125 on the exterior face configured to accept user input, and insulating material 140 within or lining the walls and door(s) of the refrigerated lockers. The operating temperature of the refrigerated delivery lockers may be adjustable, as to allow each unit to also function as a freezer unit if required for delivery of frozen groceries. Optionally, the system may be configured with a designated freezer unit which may receive the first pass of the refrigerant as to achieve the maximum temperature drop in the freezer, before passing the refrigerant to a second loop in the refrigerator unit. Alternatively, the system may share a single heat exchanger loop in the freezer unit which shares cool air with the refrigeration unit, cooling the refrigeration unit by operation of the freezer unit. It is also possible that each locker may have its own refrigeration loop and designated refrigeration components wherein there is no sharing of any refrigerant or cooled air between units. Also pictured in this embodiment are air vents 130/135 for the intake of cool air and output of hot air which may be useful for operation of the refrigeration system, as to avoid having a large radiator positioned on the exterior or interior of the unit.

The secured delivery receptacle system may further comprise a central control unit including a central processing unit, an electronic storage drive, a transmitter, a receiver, and internet connection means. The internet connection means may include ethernet ports for accepting a wired local area network connection, or an LTE (Long Term Evolution 4G wireless network) enabled SIM card (or eSIM) and a transceiver enabling communication over an LTE network. The user interface and control unit may be integrated into a single master control device, such as an LTE enabled tablet or smartphone. The central control unit may also include hardware necessary for 5G communications.

The secured delivery receptacle system may further comprise a camera located on the exterior of the unit as to record video or capture images upon input to the user interface, when the system detects movement, or otherwise detects the presence of a person in the area of the system. The camera configured to capture images or video from the exterior of the unit may store the recorded images or video on the electronic storage drive of the unit, and may transmit the footage to the owner of the unit, upon request or as is necessary in response to suspected tampering, theft, or vandalism. Transmission of the data may be accomplished by direct download, or communication over the internet using a LAN or LTE network.

The number of lockers on the unit may vary depending on the size and intended placement of the unit; a larger home with multiple families may utilize a larger unit as to allow for multiple deliveries in the various lockers, while a smaller home occupied by a single family may utilizes a smaller unit with only a few lockers. If there are multiple refrigeration lockers, they may also be of varying size. It may be advantageous to use a smaller refrigeration locker as a freezer locker for frozen goods as it will consume less energy to cool a smaller locker, and there are likely to be fewer frozen goods compared to non-frozen groceries.

FIG. 2 shows a front view of a secured delivery receptacle system 100 of present embodiments but further illustrates the electrical connections 205 between the central master control device 210 and the securing means of the lockers. The securing means of the lockers may include electronically enabled mechanical latches, or magnetic locks, as to allow for the locker to be secured upon input of a package by a delivery agent. There may also be included additional electrical connections 200 between the refrigerated lockers and the master control device to power and communicate with components of refrigeration system, such as the thermometer, compressor, and interior fans. Such electrical connections may be used to turn the refrigeration system on and off, in response to input into the user interface and a command from the master control device 210.

Prior to input of a package, the delivery agent may input the intended recipient of the package into the system through the user interface. Following confirmation of the recipient upon comparison with the system's records, a locker suitable for the specified delivery should open, the package be placed inside, and locked upon closing the door. Alternatively, lockers of increasing size may open until one of suitable size for the given delivery opens, and the parcel is delivered. A delivery agent may be asked to certify that a package has been delivered to a locker on the user interface. The locking mechanism may automatically engage upon closing the door. The user may then be sent a system generated secure code via email or text message which will allow them to receive the package upon input of the secure code to the master control device 210. The secured delivery receptacle system may be equipped with a means for detecting within the lockers for detecting whether a locker is empty or occupied, and such means may include infrared sensors, weight sensors, or optical sensors. Such detection means may be useful if a locker door is blown shut by the wind, or in some other accidental manner, which may result in the erroneous notification to an intended recipient of a package of a delivery which has not if fact been delivered, and the recipient not being able to pick up their package. In the first case where a delivery agent accidentally closes a locker door without placing a package inside, the detection means may notify the delivery agent of the mistake and reopen the door. In the second case where a consumer accidentally closes a locker door without picking up their package, the detection means may signal to the master control unit that the package is still inside, and allow the consumer to reenter their code to open the locker again.

The secured delivery receptacle system may further comprise a barcode reader which is connected to the central control unit which will automatically log packagers which have been indicated to the system as incoming, automatically opening the correct sized locker which may be refrigerated (if necessary), and automatically inform the intended recipient that they have a parcel delivery waiting for them. In communal embodiments, such will also include a secured code to allow for the secured retrieval of the parcel. Information associated with the bar code may include the package size, the recipient, if the contents require refrigeration, and other useful information.

The secured delivery receptacle system of present embodiments may further be equipped with a battery as to allow for continuous operation of the system even during power outages. Depending on the incoming deliveries, capacity of the battery, and length of the outage, the system may be configured as to power only the user interfaces, central control unit, and securing means while not powering the refrigeration components as to extend the battery life and operating time of the unit. For instance, if the power has been out less than a set amount of time, e.g. 1 hour, then the system may provide for full operation of the system during the outage including operation of the refrigerated delivery lockers. For longer outages, it may be desirable to conserve energy by not operating the refrigerated units, as to allow for operation of the mater control unit and electronically enabled locks so recipients can still pick up their packages. The battery may be located within the housing to protect it from the elements, but may also be located on the exterior of the unit. If the battery is located on the exterior of the housing, it may be advantageous to enclose the battery in a protective casing to protect it from the elements, debris, or accidental impacts.

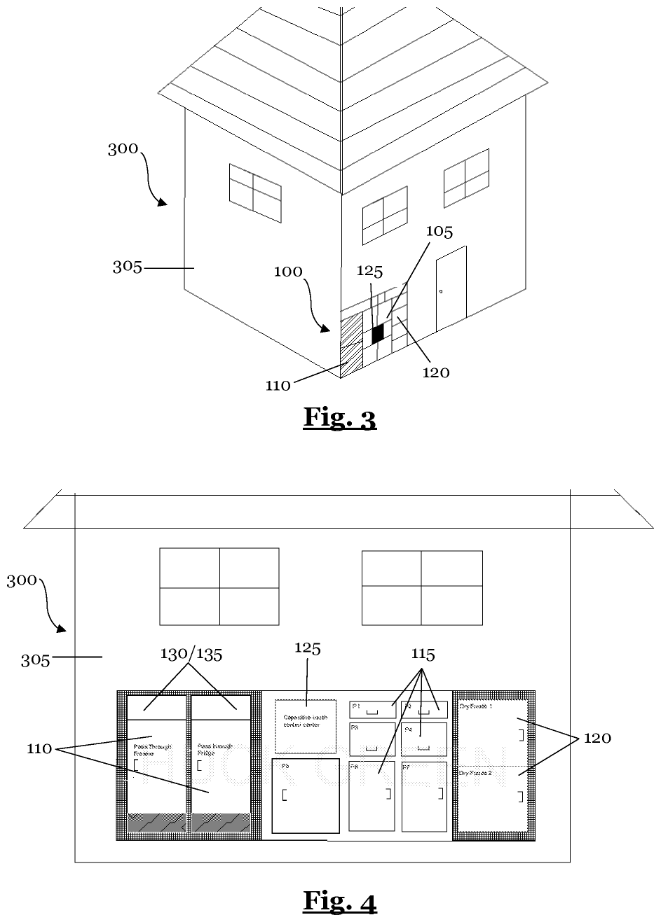

FIG. 3 shows a perspective view of the secured delivery receptacle system 100 of present embodiments as installed into an exterior wall 305 of a house 300. In such embodiments the secured delivery receptacle system 100 should be installed at the ground level of an exterior wall 305 of a house 300 in a location which is readily accessible to delivery agents, as to permit them to access the secured delivery receptacle system without intruding to private areas of the home. Also shown on the secured delivery receptacle system 100 is the housing 105, exterior user interface 125, the refrigerated lockers no, and standard parcel lockers 120 of varying size. While FIG. 3 shows the secured delivery receptacle system installed in the corner of two exterior walls, the secured delivery receptacle system of such an embodiment may be installed at any point along the exterior wall. However, it may be advantageous to install the secured delivery receptacle system 100 at the corner of two exterior walls as to reduce heat loss from the home, reduce the impact on the structural integrity of the wall, and increase security due to additional anchor points at the corner of a building, among other advantages.

When installing the secured delivery receptacle system into the wall of a building, the system may be optimized by retaining the insulation material in the walls surrounding the system as to reduce heat loss from the refrigerated lockers. The insulation material should be trimmed as necessary to make space for the secured delivery receptacle system, but should go right up to the edge of the housing as to minimize heat losses from the system. A barrier, possibly a thin non-reactive film such as a plastic polymer, may be placed between the insulation material and the housing of the unit. Depending on the size of a particular secured delivery receptacle system model, it may also be necessary to remove some of the studs or structural components of the wall as to make space for the unit. In such cases, the housing of the unit may make contact with the floor and be configured as to be coextensive with the remaining portions of the structural components in order to maintain the structural integrity of the wall.

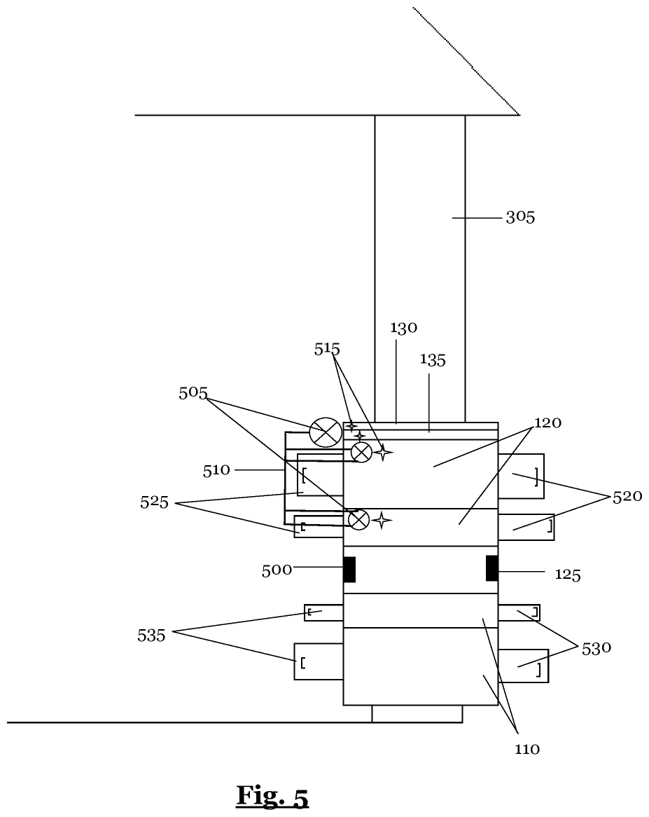

FIG. 4 shows a front view of the secured delivery receptacle system 100 of present embodiments as installed into an exterior wall 305 of a house 300. Also pictured in this embodiment are air vents 130/135 for the intake of cool air and output of hot air which may be useful for operation of the refrigeration system, as to avoid having a large radiator positioned on the exterior or interior of the unit. Using an interior heat exchanger which removes heat by using convection and outside air may be preferable, as unlike traditional refrigerators it will not dissipate the excess heat in the home, will dissipate heat outside through outgoing air vent 135, and will not utilize a hot radiator on the exterior or interior face of the unit which may create a hazard for the users.

FIG. 5 shows a side view of the secured delivery receptacle system present embodiments as installed into an exterior wall 305 of a house. The embodiment of FIG. 5 comprises: housing 105 defining an enclosed structure; refrigerated lockers 110 located within the housing which can be accessed through a first exterior access door located on the exterior face and through a first interior access door located on the interior face permitting; parcel lockers of varying size 120 located within the housing which can be accessed through a second exterior access door located on the exterior face and a second interior access door located on the interior face; an exterior user interface 125; an interior user interface 500; and intake/output air vents 130/135 are present. As in previously embodiments, the secured delivery receptacle system may include securing means located on the housing and within the lockers for securing the lockers to prevent unauthorized access to the lockers, detection means in the lockers for detecting whether a locker is empty or occupied, and a central control unit connected to the securing means, detection means and refrigeration system.

Not shown in prior figures are the interior user interface 500, insulted exterior doors 520 for the refrigerated lockers, exterior doors for the parcel lockers 530, insulted interior doors for the refrigerated lockers 525, interior doors for the parcel lockers 535, and components of the refrigeration system. The components of the refrigeration system may comprise: a compressor located within the housing, an expansion valve located within the housing, at least one heat exchanger 505, wherein one or more of the heat exchangers may be convection-based heat exchangers located within the housing attached to the air vents, one or more fans 515 facilitating movement of air to the convention-based heat exchangers from the environment, and then from the convention-based heat exchangers to the environment and out of the system, a second heat exchanger located within or attached to the refrigerated delivery locker, an interior fan located within the refrigerated delivery locker, and refrigerant lines 510 facilitating movement of the working fluid between the heat exchangers, connecting the convection-based heat exchanger, compressor, expansion valve, and second heat exchanger. The system may further comprise an intake air vent within the housing beginning at the exterior face, an output air vent within the housing ending at the exterior face, both of which are connected to the convection-based heat exchanger. The system may further comprise insulating material located within or lining the walls of the locker, and a thermometer located within the refrigerated delivery locker configured to start the compressor upon the locker reaching a specified temperature. In addition, there may be additional valves located along the refrigeration lines as to restrict the flow of refrigerant to certain refrigeration loops when not in use as to allow the for the operation of multiple refrigerated lockers with fewer components, possibly utilizing a common compressor and primary convection based heat exchanger.

The refrigeration system should be connected to and controlled by the master control device, and should only be turned on as necessary to refrigerate deliveries, and promptly turned off after removal of the delivery, possibly automatically in response to opening and closing of an interior door. The detection means discussed in prior embodiments may also be useful in this embodiment to confirm whether a locker is empty or occupied before turning the refrigeration off or on. Further, in embodiments wherein the secured delivery receptacle system is installed into an exterior wall of a building; it may be desirable for all of the locker doors to be insulated as to reduce heat transfer between the interior of the house and the external environment. During cold or hot seasons where heat transfer is of concern to a household, there may be included additional insulating inserts which can be placed within unused lockers as to further reduce the heat transfer between the interior of the house and the external environment. Such inserts may be secured to the interior of the locker by various means including: snaps, magnets, tightly fitting inserts which are snuggly pushed in, hook and loop, or other fastening means. The inserts may include handles to allow them to be easily removed.

The placement and configuration of the refrigeration components may vary based upon the size of the unit and the number of refrigerated lockers, and vary based upon the intended operating temperature of the lockers. For instance, a small system which utilizes a small refrigerated locker and a larger refrigerated locker may be able to operate using only one interior heat exchanger and fan, where the cooling action of the single heat exchanger is sufficient to cool both lockers. If one of the refrigerated lockers is being operated as a freezer, the secondary refrigeration locker which operates in a higher temperature range may be placed downstream of primary freezer locker, the freezer locker receiving the coldest air first, which then flows to the larger refrigerated locker at which operates at a higher temperature. Such embodiments may utilize an air vent between the freezer and refrigeration lockers. It is also possible that there may be embodiments where there is a small frozen goods compartment located within a refrigeration locker. Alternatively, each refrigerated locker may utilize its own convection-based heat exchanger, and own refrigerant supply, as to be able to operate completely independently of one another. In other embodiments, each refrigerated locker may utilize its own convection-based heat exchanger but may utilize a common refrigerant supply, compressor, and common central heat exchanger as is shown in FIG. 5. In such embodiments, where multiple lockers are present, there may also be included valves attached to the refrigerant lines which control the flow of the working fluid, only allowing a portion of the working fluid to flow into each of the refrigerated locker's designated heat exchangers, while preserving additional compressed working fluid for use by the remaining refrigerated lockers. The valves may be electronically operated and may be connected to the master control unit as to interface with the unit, and only permit operation of individual refrigerated lockers as is necessary to refrigerate deliveries in order to conserve energy. In such embodiments, it may be possible to only operate one of the refrigerated lockers at a time without having to operate the other lockers in order to conserve energy, notwithstanding their configuration as part of a single loop.

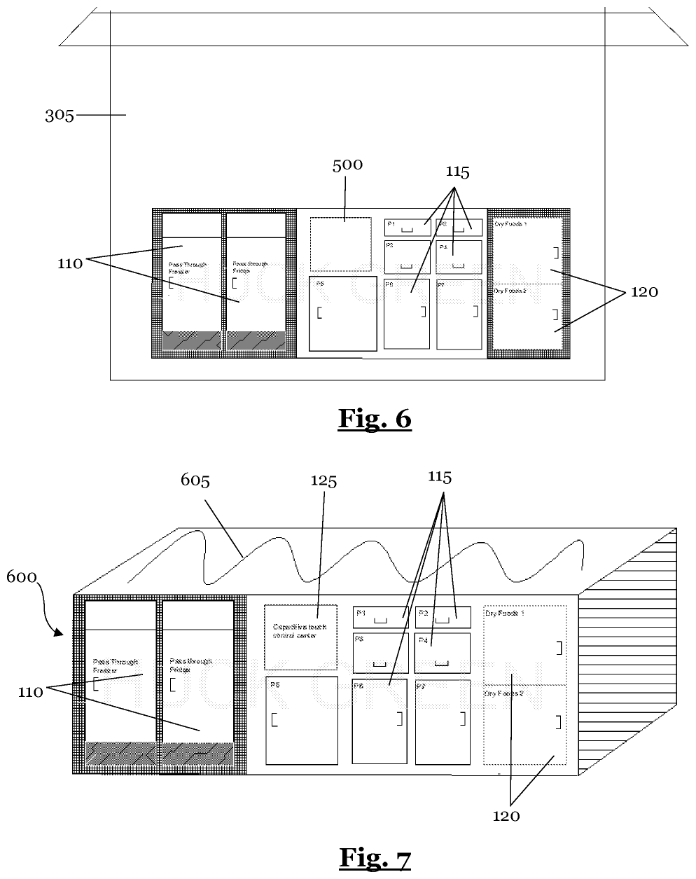

FIG. 6 shows an interior view of an alternative embodiment of the secured delivery receptacle system installed into the exterior wall of a house 305 with a plurality of refrigerated lockers 110, dry food lockers 120, and parcel lockers 115, all of varying sizes. Embodiments of the present invention are not limited to configurations with a particular number of lockers or particular locker sizes.

FIG. 7 shows a perspective view of an alternative embodiment of the secured delivery receptacle system 600 where the system is configured as a stand-alone unit. The stand-alone unit may be secured to the ground where it is located in order to provide increased security. Attachment to the ground may not be necessary for larger units which are too heavy to easily be stolen. Like other embodiments, the standalone unit has refrigerated lockers 110 of variable temperature as to allow for the delivery of frozen goods, located within the housing which can be accessed through a first access door located on the exterior face, dry food lockers 120, parcel lockers 115 located within the housing which can be accessed through a second access door located on the exterior face, and a user interface 125, which may also be the master control unit. For such standalone embodiments, a radiator 605 located on the exterior of the housing may be used as the primary external heat exchanger for the unit and an exterior convection-based heat exchanger and radiator fans may not be required. Since the unit is large and has up to five of its six faces exposed to the air, a radiator attached to the exterior of the unit can effectively dissipate the heat from the system without presenting a hazard to users, as there is ample space to place the radiator in a location where consumers and delivery agents are unlikely to contact it, such as the top of the unit. Similar to other embodiments, the standalone unit is not limited to a particular configuration of lockers. The size of the unit and the configuration of lockers may vary by model, and a given model with a specified number of lockers may be chosen by the purchaser in order to best suit their needs. For instance, large apartment communities or other large communal living facilities may benefit from larger units with many lockers which can accommodate many deliveries. The standalone unit may be placed in a central location such as a mail room or parking garage. In such embodiments, it may be especially useful to utilize individual security codes generated in response to the delivery for specific tenants or addresses, and securely communicated to the recipient in electronic format as to allow them to open the locker and safely remove their delivery.

One of ordinary skill in the art will recognize the inventive principles disclosed are not limited to the embodiments disclosed herein, and that various aspects of the disclosed embodiments can be combined to achieve additional embodiments.

What is claimed is:

1. A secured delivery receptacle system comprising:
a housing defining an enclosed structure;
an exterior face located on the housing;
first and second access doors on the exterior face;
a refrigerated delivery locker, having a refrigeration system located on top of and within the housing, accessible through the first access door;
a parcel locker located within the housing accessible through the second access door;
a securing means located on the housing and within the lockers for securing the lockers to prevent unauthorized access to the lockers;
a user interface on the exterior face configured to accept user input; and
a detection means in the lockers for detecting whether a locker is empty or occupied;
a central control unit connected to the user interface, the securing means, the detection means, and the refrigeration system,
wherein the refrigerated delivery locker is configured to be turned on and off in response to input from the central control unit.

2. The secured delivery receptacle system of claim 1 wherein the securing means to prevent unauthorized access to the lockers are electronically enabled magnetic locks or electronically enabled mechanical latches.

3. The secured delivery receptacle system of claim 2 wherein the securing means are electronically operable by the central control unit and are configured to unlock in response to user input to the user interface.

4. The secured delivery receptacle system of claim 1 wherein the means for detecting whether a locker is empty or occupied are infrared sensors, weight sensors, or optical sensors.

5. The secured delivery receptacle system of claim 1 wherein the central control unit comprises:
a central processing unit;
an electronic storage drive;
a transmitter;
a receiver; and
a means for connecting to the internet.

6. The secured delivery receptacle system of claim 5 wherein the means for connecting to the internet includes ethernet ports for accepting a wired local area network connection, or an LTE enabled sim card and a transceiver enabling communication over an LTE network.

7. The secured delivery receptacle system of claim 5 wherein the user interface is a graphical user interface with a touch display, and wherein central control unit and graphical user interface are integrated into a single master control device.

8. The secured delivery receptacle system of claim 7 wherein the single master control device is an LTE enabled tablet, or smartphone.

9. The secured delivery receptacle system of claim 5 further comprising:
a camera configured to capture images or video from the exterior face of the unit, wherein the camera is connected to the central control unit, and wherein the captured image or video files are stored on the electronic storage drive.

10. The secured delivery receptacle system of claim 1 further comprising:
a battery configured to at least allow operation of the central control unit and securing means in the absence of a continuous power supply.

11. The secured delivery receptacle system of claim 1 further comprising:
a plurality of refrigerated delivery lockers located within the housing which can be accessed through a plurality of refrigeration access doors located on the exterior face; and
a plurality of parcel lockers located within the housing which can be accessed through a plurality of access doors located on the exterior face.

12. The secured delivery receptacle system of claim 1 wherein the refrigeration system comprises:
a refrigerant;
a radiator located on the exterior of the housing;
a compressor located within the housing;
an expansion valve located within the housing;
a heat exchanger located within or attached to the refrigerated delivery locker;
an interior fan located within the refrigerated delivery locker;
refrigerant lines connecting the radiator, compressor, expansion valve, and heat exchanger;
insulating material located within or lining the walls of the locker; and
a thermometer located within the refrigerated delivery locker configured to start the compressor upon the locker reaching a specified temperature by signaling the central control unit.

13. A secured delivery system comprising:
a housing defining an enclosed structure;
an exterior face located on the housing;
an interior face located on the housing;
first and second exterior access doors on the exterior face;
first and second interior access doors on the interior face;
a refrigerated delivery locker, having a refrigeration system located within the housing, which can be accessed through the first exterior access door and the first interior access door;
a parcel locker located within the housing which can be accessed through the second exterior access door and the second interior access door;
a securing means located on the housing and within the lockers for securing the lockers to prevent unauthorized access to the lockers;
a user interface on the exterior face configured to accept user input; and
a detection means in the lockers for detecting whether a locker is empty or occupied;
a central control unit connected to the securing means and detection means;
a second user interface on the interior face configured to accept user input,
wherein the refrigerated delivery locker is configured to be turned on and off in response to input from the central control unit,
wherein the system is configured to be built into an exterior wall of a building, and wherein the lockers are accessible from either side of the wall the system is built into.

14. The secured delivery receptacle system of claim 13 wherein the securing means to prevent unauthorized access to the lockers are electronically enabled magnetic locks or electronically enabled mechanical latches, and wherein the securing means are electronically connected to the central control unit and are configured to unlock in response to user input to the user interface.

15. The secured delivery receptacle system of claim 13 wherein the means for detecting whether a locker is empty or occupied are infrared sensors, weight sensors, or optical sensors.

16. The secured delivery receptacle system of claim 13 wherein the central control unit comprises:
a central processing unit;
an electronic storage drive;
a transmitter;
a receiver; and
a means for connecting to the internet.

17. The secured delivery receptacle system of claim 16 wherein the means for connecting to the internet includes ethernet ports for accepting a wired local area network connection, or an LTE enabled sim card and a transceiver enabling communication over an LTE network.

18. The secured delivery receptacle system of claim 16 further comprising:
a camera configured to capture images or video from the exterior face of the unit, wherein the camera is connected to the central control unit, and wherein the captured image or video files are stored on the electronic storage drive.

19. The secured delivery receptacle system of claim 13 further comprising:
a plurality of refrigerated delivery lockers; and
a plurality of parcel lockers.

20. The secured delivery receptacle system of claim 13 wherein the refrigeration system comprises:
a refrigerant;
an intake air vent within the housing beginning at the exterior face;
an output air vent within the housing ending at the exterior face;
a convection-based heat exchanger located within the housing and attached to the air vents;
a compressor located within the housing;
an expansion valve located within the housing;
an interior fan located within the refrigerated delivery locker;
a second heat exchanger located within or attached to the refrigerated delivery locker;
refrigerant lines connecting the convection-based heat exchanger, compressor, expansion valve, and second heat exchanger;
insulating material located within or lining the walls of the locker; and
a thermometer located within the refrigerated delivery locker configured to start the compressor upon the locker reaching a specified temperature by signaling the central control unit.
